(19) United States
(12) Patent Application Publication
(10) Pub. No.: US 2015/0099064 A1
(43) Pub. Date: Apr. 9, 2015

(54) PATTERN FORMATION METHOD AND MAGNETIC RECORDING MEDIUM MANUFACTURING METHOD

(71) Applicant: Kabushiki Kaisha Toshiba, Minato-ku (JP)

(72) Inventors: Akira Watanabe, Kawasaki-shi (JP); Kazutaka Takizawa, Kawasaki-shi (JP); Kaori Kimura, Yokohama-shi (JP)

(73) Assignee: Kabushiki Kaisha Toshiba, Minato-ku (JP)

(21) Appl. No.: 14/142,244

(22) Filed: Dec. 27, 2013

(30) Foreign Application Priority Data
Oct. 7, 2013 (JP) 2013-210300

(51) Int. Cl. B05D 1/32

(52) U.S. Cl. CPC B05D 1/322
USPC 427/127

(57) ABSTRACT

According to one embodiment, a pattern formation method includes forming a surface treatment polymer film on a substrate, applying a solution containing a monomer or oligomer of a surface treatment polymer material to a surface of the surface treatment polymer film, forming a self-assembled layer by coating the surface treatment polymer film with a coating solution containing a block copolymer having at least two types of polymer chains, and forming a microphase-separated structure in the self-assembled layer by annealing, and optionally removing one type of a polymer layer from the microphase-separated structure, thereby forming convex patterns by a remaining polymer layer.

### CROSS-REFERENCE TO RELATED APPLICATIONS

This application is based upon and claims the benefit of priority from Japanese Patent Application No. 2013-210300, filed Oct. 7, 2013, the entire contents of which are incorporated herein by reference.

### FIELD

Embodiments described herein relate generally to a pattern formation method and magnetic recording medium manufacturing method.

### BACKGROUND

Mask patterns using a diblock copolymer or metal fine particles can be used in pattern processing of a magnetic recording layer of a magnetic recording medium, or in semiconductor lithography.

A coating solution is prepared by a diblock copolymer dissolved or metal fine particles mixed in a solvent, and a coating layer is formed on a substrate.

A polymer film is performed as a grafted layer on the substrate. This makes it possible to reduce the influence of the surface energy from the substrate, and secure the wettability of a medium contained in the coating solution.

As a method of improving the wettability of the medium, it is generally possible to increase the thickness of the grafted polymer film by using a polymer forming on the medium. In a step of transferring micropatterns of about 10 nm, however, the transfer properties deteriorate if the polymer film on the substrate surface is thick. When using the polymer film on the substrate surface as a chemically-Patterned guide for an array of micropatterns, if the thickness of the film is large, physical concavo-convex shape of chemically-patterned guide obstruct an array more than the substrate surface energy.

On the other hand, if the thickness of the polymer film on the substrate surface is decreased, the influence of the surface energy from the substrate increases. Consequently, the substrate surface energy changes as the thickness is decreased, and this worsens the wettability.

As described above, decreasing the thickness of the polymer film on the substrate surface and the wettability of the substrate surface are contradictory.

### BRIEF DESCRIPTION OF THE DRAWINGS

FIGS. 1A, 1B, 1C and 1D schematically show a pattern formation method according to an embodiment;

FIGS. 2A, 2B and 2C are schematic views of upper-surface SEM images of various etching patterns;

FIG. 3 is a graph showing the relationship between the thickness of a surface-treated polymer layer and the contact angle; and

FIGS. 4A, 4B, 4C, 4D, 4E, 4F and 4G show the manufacturing method of a magnetic recording medium according to an embodiment.

### DETAILED DESCRIPTION

A pattern formation method according to the first embodiment includes

forming a surface treatment polymer film on a substrate by using a surface treatment polymer material,

applying a solution containing a monomer or oligomer of the surface treatment polymer material to a surface of the surface treatment polymer film,

coating the surface treatment polymer film, to which the solution containing the monomer or oligomer of the surface treatment polymer material is applied, with a block copolymer coating solution containing a block copolymer having at least two types of polymer chains and a first solvent, thereby forming a self-assembled layer made of the block copolymer,

forming a microphase-separated structure in the self-assembled layer by annealing the substrate, and

optionally removing one type of a polymer layer from the microphase-separated structure, thereby forming convex patterns by a remaining polymer layer.

Also, a pattern formation method according to the second embodiment includes

forming a surface treatment polymer film on a substrate by using a surface treatment polymer material,

applying a solution containing a monomer or oligomer of the surface treatment polymer material to a surface of the surface treatment polymer film, and

coating the surface treatment polymer film, to which the monomer or oligomer of the surface treatment polymer material is applied, with a metal fine particle coating solution containing metal fine particles and a second solvent, thereby forming a metal fine particle layer.

Furthermore, a magnetic recording medium manufacturing method according to the third embodiment is an application of the pattern formation method according to the first embodiment, uses a magnetic recording medium instead of the substrate, and includes transferring the three-dimensional patterns obtained by the pattern formation method according to the first embodiment to a magnetic recording layer of the magnetic recording medium.

In addition, a magnetic recording medium manufacturing method according to the fourth embodiment is an application of the second pattern formation method, uses a magnetic recording medium instead of the substrate, and includes transferring the three-dimensional patterns based on the metal fine particle layer obtained by the pattern formation method according to the second embodiment to a magnetic recording layer of the magnetic recording medium.

In the first to fourth embodiments, a polymer film as a grafted layer is formed on the surface of a layer to be processed such as a substrate, and a monomer or oligomer of this polymer is applied to the surface of the polymer film. This makes it possible to remove an extra polymer component remaining on the substrate surface after the polymer film is formed, and improve the wettability of a block copolymer coating solution or metal fine particle coating solution to be further applied to the polymer film, thereby improving the pattern array of the block copolymer or metal fine particles.

The array can be improved by entrapping the monomer in the substrate surface treatment layer, and the array improving effect is larger for a solvent in which the boiling point of the monomer is high.

Also, if the boiling point of the monomer is low, it is possible to obtain the same effect by raising the boiling point by using an oligomer such as a dimer, trimer, or tetramer.

The surface treatment polymer film can have a thickness of 3 to 10 nm.

If the thickness of the surface treatment polymer film is less than 3 nm, a uniform film is difficult to form, and the surface treatment polymer film is often influenced by the surface energy of the layer to be processed as an underlayer. If the thickness of the surface treatment polymer film exceeds 10 nm, the wettability of the block copolymer coating solution or metal fine particle coating solution improves, but the transfer properties deteriorate in a step of transferring particularly micropatterns of about 10 nm, and physical projections and recesses obstruct an array more than the surface energy of the layer to be processed.

Furthermore, the pattern formation method according to the embodiment is also applicable to semiconductor lithography, as well as a processed medium.

The embodiments will be explained in more detail below.

The pattern formation method according to the embodiment includes

forming a surface treatment polymer film made of a surface treatment polymer material on a layer to be processed such as a substrate,

cleaning the substrate having the surface treatment polymer film by using a monomer or oligomer forming the surface treatment polymer film,

forming a mask template layer on the substrate having the cleaned surface treatment polymer film by using a coating solution for forming as a mask template,

forming three-dimensional patterns on the mask template layer by etching, and

transferring the three-dimensional patterns of the mask template layer to the layer to be processed such as the substrate.

The substrate is not particularly limited. Examples are substrates obtained by depositing various metal films on a silicon substrate or glass substrate, and substrates obtained by stacking a carbon or silicon hard mask on these substrates.

As the layer to be processed, it is possible to use, for example, a magnetic recording layer, its protective layer, a silicon or carbon hard mask layer, or a mask layer formed by a resist or the like.

Examples of the surface treatment polymer material to be used as the surface treatment polymer film are derivatives of polyacrylic acid, derivatives of polymethacrylic acid, substituted and nonsubstituted polyethylene oxide and polystyrene, polyvinylnaphthalene, polyvinylanthracene, polydimethylsiloxane, and polysilsesquioxane.

In particular, polystyrene, polyethylene terephthalate, poly-4-vinylpyridine, ethyl polymethacrylate, methyl polymethacrylate, butyl polymethacrylate, methyl polyacrylate, ethyl polyacrylate, butyl polyacrylate, poly-2-vinylpyridine, poly-N-N-dimethylacrylamide, 2-hydroxyethyl polyacrylate polymethacrylate, polyvinyl acetate, isobutyl polymethacrylate, polyvinyltoluene, 2-ethylhexyl polyacrylate, polymethylstyrene, polyester, polyethylene, polyvinyl chloride, and polyethylene oxide can be used as the surface treatment polymer material, because a monomer of any of these materials is a gas or liquid, so a monomer or oligomer of any of these materials can easily be applied in the form of a solution to the surface of the surface treatment polymer film.

The boiling point of a monomer of each of polystyrene, methyl polymethacrylate, ethyl polymethacrylate, butyl polymethacrylate, isobutyl polymethacrylate, polyacrylic acid, and polyvinyltoluene is about 100 to 170° C. When any of these materials is applied as a solution to the surface treatment polymer film, therefore, spin drying by rotation is easy to perform, and the volatilization of the monomer remaining in the film can be suppressed.

A method of bonding the surface treatment polymer film to the substrate can be any method as long as adsorption occurs on an inorganic material to be used as the substrate. Examples are a method of causing a hydrolysis reaction on the substrate by using a hydroxyl group, a silane coupling agent that contains an organic silicon compound and adsorbs by causing hydrolysis and a reaction of silanol, and a gold-thiol bonding reaction.

As the mask template layer, it is possible to use metal fine particles, or a block copolymer that forms a microphase-separated structure by annealing.

A diblock copolymer can be used as the block copolymer for forming a microphase-separated structure.

Examples of the diblock copolymer that forms a microphase-separated structure are polybutadiene-block-polydimethylsiloxane, polybutadiene-block-poly-4-vinylpyridine, polybutadiene-block-polymethylmethacrylate, polybutadiene-block-poly-t-butylmethacrylate, polybutadiene-block-poly-t-butylacrylate, polybutadiene-block-sodium polyacrylate, polybutadiene-block-polyethylene oxide, poly-t-butylmethacrylate-block-poly-4-vinylpyridine, polyethylene-block-polymethylmethacrylate, poly-t-butylmethacrylate-block-poly-2-vinylpyridine, polyethylene-block-poly-2-vinylpyridine, polyethylene-block-poly-4-vinylpyridine, polyisoprene-block-poly-2-vinylpyridine, poly-t-butylmethacrylate-block-polystyrene, polymethylacrylate-block-polystyrene, polybutadiene-block-polystyrene, polyisoprene-block-polystyrene, polystyrene-poly-block-poly-2-vinylpyridine, polystyrene-block-poly-4-vinylpyridine, polystyrene-block-polydimethylsiloxane, polystyrene-block-poly-N,N-dimethylacrylamide, polystyrene-block-polyethylene oxide, polystyrene-block-polysilsesquioxane, polymethylmethacrylate-block-polysilsesquioxane, polystyrene-block-polymethylmethacrylate, poly-t-butylmethacrylate-block-polyethylene oxide, and polystyrene-block-polyacrylic acid.

In particular, polystyrene-block-polymethylmethacrylate, polystyrene-block-polydimethylsiloxane, polystyrene-block-polyethylene oxide, polystyrene-block-polysilsesquioxane, and polymethylmethacrylate-block-polysilsesquioxane are excellent as materials to be used in the embodiments because an interaction parameter of copolymerized polymers is large, so a stable phase-separated shape can be formed. Polystyrene-block-polydimethylsiloxane, polystyrene-block-polysilsesquioxane, and polymethylmethacrylate-block-polysilsesquioxane are particularly excellent when used as an etching mask because one of polymers contains silicon, so the etching resistance is high. Furthermore, polystyrene-block-polydimethylsiloxane is particularly excellent when forming narrow patterns by using solvent annealing because the glass transition temperature of polydimethylsiloxane is less than or equal to room temperature.

In addition, polystyrene-block-polyethylene oxide is particularly superior as a material to be used in the embodiments because an effective interaction parameter can be increased by the addition of a metal salt or silicon compound.

The fine particle material to be used as the mask template layer can be selected from, for example, noble metals such as Au, Ag, Pt, Pd, Ru, Ir, and Rh, base metals such as Fe, Al, Ti, Co, Ni, and Cr, and semiconductors such as Si, Ge, Ga, and C. It is also possible to similarly use alloys and products mainly containing these materials.

The surface of each fine particle is modified by a protective group made of a polymer chain, and fine particles are physicochemically separated by the polymer chain modifying the surfaces.

As a combination of the surface treatment polymer film and mask template layer, the surface treatment polymer film can be formed by that material of the mask template layer, which comes in contact with the substrate.

For example, when polystyrene (PS)-polydimethylsiloxane (PDMS) as a diblock copolymer is used as the mask template layer, PDMS forms an island-like structure having a spherical phase, and PS forms a sea-like structure having a continuous phase surrounding PDMS, the substrate surface treatment layer can be formed by PS that comes in contact with the substrate and forms the sea-like structure. Styrene as a monomer of polystyrene can be used in cleaning after the surface treatment polymer film is formed on the substrate.

Also, when Fe₃O₄ coated with stearic acid as a protective group is used as the mask template and methyl polymethacrylate is used as a binder, methyl polymethacrylate forming a continuous phase can be used as the surface treatment polymer film on the substrate, and methyl methacrylate can be used as a cleaning solution after the surface treatment polymer film is formed.

Table 1 below shows other effective combinations of materials.

TABLE 1

| Main component of | | | |
|---|---|---|---|
| material forming | | | |
| continuous phase | Surface treatment | Cleaning | Boiling |
| of mask template | polymer layer | monomer | point |
| Polystyrene | Polystyrene | Styrene | 145° C. |
| Poly(ethylene | Poly(ethylene | Ethylene glycol | 197° C. |
| terephthalate) | terephthalate) | | |
| Polyester | Polyester | Ethylene glycol | 197° C. |
| Poly(4-vinyl- | Poly(4-vinyl- | 4-vinyl- | 65° C. |
| pyridine) | pyridine) | pyridine | |
| Poly(methyl | Poly(methyl | Methyl | 101° C. |
| methacrylate) | methacrylate) | methacrylate | |
| Poly(tert-butyl | Poly(t-butyl | tert-Butyl | 132° C. |
| methacrylate) | methacrylate) | methacrylate | |
| Poly(tert-butyl | Poly(t-butyl | tert-Butyl | 62° C. |
| aerylate) | acrylate) | acrylate | |
| Poly(2-vinyl- | Poly(2-vinyl- | 2-vinylpyridine | 80° C. |
| pyridine) | pyridine) | | |
| Poly(N-N-dimethyl- | Poly(N-N-dimethyl- | N,N-dimethyl- | 80° C. |
| acrylamide) | acrylamide) | acrylamide | |
| Poly(acrylic acid) | Poly(acrylic acid) | Acrylic acid | 139° C. |
| Poly(2-hydroxyethyl | Poly(2-hydroxyethyl | 2-Hydroxyethyl | 85° C. |
| methacrylate) | methacrylate) | methacrylate | |
| Polyvinyl acetate | Polyvinyl acetate | Vinyl acetate | 72° C. |
| Poly(isobutyl | Poly(isobutyl | Isobutyl | 155° C. |
| methacrylate) | methacrylate) | methacrylate | |
| Polyvinyltoluene | Polyvinyltoluene | Vinyltoluene | 169° C. |
| Poly(ethyl | Poly(ethyl | Ethyl | 118° C. |
| methacrylate) | methacrylate) | methacrylate | |
| Poly(2-Ethylhexyl | Poly(2-Ethylhexyl | 2-Ethylhexyl | 215° C. |
| acrylate) | acrylate) | acrylate | |
| Polymethylstyrene | Polymethylstyrene | Methylstyrene | 170° C. |

Also, when using a material in which the boiling point of a monomer forming the surface treatment polymer film is 100° C. or less, the energy of the surface treatment polymer film can be made close to that of a bulk properties in polymer film by raising the boiling point to about 150° C. by using an oligomer such as a dimer, trimer, or tetramer.

When using as the oligomer, it is also possible to use as the surface treatment polymer, for example, polyethylene oxide, polyester, or polyethylene whose monomer is a gas, instead of the materials described in Table 1.

To perform spin drying, the viscosity of the cleaning solvent can be set at 2 mPa·s or less, and can also be set at 1 mPa·s or less, at room temperature (20° C.)

The relationship between the annealing temperature and molecular weight for forming the microphase-separated structure of the block copolymer and the annealing step for forming the phase-separated shape of the block copolymer will be explained below.

Thermal annealing is a step of keeping a sample in a vacuum or inert gas, and generating a phase-separated structure by performing a heating process. Solvent annealing is a step of generating a phase-separated structure by keeping a sample in a solvent ambient. In the thermal annealing, a polymer moves and diffuses to form a phase-separated structure when the heating temperature is greater than or equal to the glass transition temperature of the polymer. In a sample kept in a solvent ambient, an annealing solvent is entrapped in the polymer film, so the glass transition temperature of the polymer decreases. When the glass transition temperature becomes lower than the process temperature, the polymer moves and diffuses to form a phase-separated structure.

A time required before phase separation is complete is correlated with the diffusion coefficient of a polymer. When the process temperature is greater than or equal to the glass transition temperature, the diffusion of a polymer can be approximated to a mass diffusion theory in a polymer gel, and a diffusion coefficient DO can be represented by the relationship indicated by:

D₀∝k_{B}T/6πM^{ν} (1)

(k_{B}: Boltzmann constant, T: absolute temperature, M: molecular weight, and ν: constant)

The diffusion coefficient is proportional to the temperature, i.e., the process temperature, and inversely proportional to the molecular weight. Therefore, the diffusion coefficient of a polymer having a large molecular weight decreases, and this prolongs the time required for phase separation. Accordingly, the diffusion coefficient of a material in which the molecular weight of a polymer is large can be increased by raising the process temperature. This makes it possible to solve the problem of the prolongation of the time of the phase separation step.

On the other hand, the diffusion coefficient of a polymer having a small molecular weight often increases more than necessary, and this sometimes poses the problem that a thin film shape formed by coating cannot be held. This problem can be solved by making the process temperature less than or equal to room temperature by using solvent annealing, thereby decreasing the diffusion coefficient.

It is empirically possible to raise the process temperature to about 50 to 200° C. when a diblock copolymer having a molecular weight of 30,000 or more, and particularly, 50,000 or more is phase-separated by solvent annealing, and lower the process temperature to about 0 to −50° C. when a diblock copolymer having a molecular weight of 10,000 or less, and particularly, 8,000 or less is phase-separated by solvent annealing.

In phase separation, it is also necessary to control the amount of annealing solvent to be entrapped in a thin film formed by the diblock copolymer. In accordance with the entrapped solvent amount, the glass transition temperature of a polymer decreases, and the diffusion coefficient of the polymer increases. In accordance with the solvent amount to be entrapped in the diblock copolymer thin film, therefore, the diffusion coefficient of a polymer must be adjusted by controlling the process temperature. In addition, the solvent vapor pressure in a chamber that causes phase separation may become greater than or equal to a saturation vapor pressure and cause condensation due to an abrupt temperature drop. Therefore, it is necessary to carefully control the temperature.

### EXAMPLES

The embodiment will be explained in more detail below by way of its examples.

### Example 1

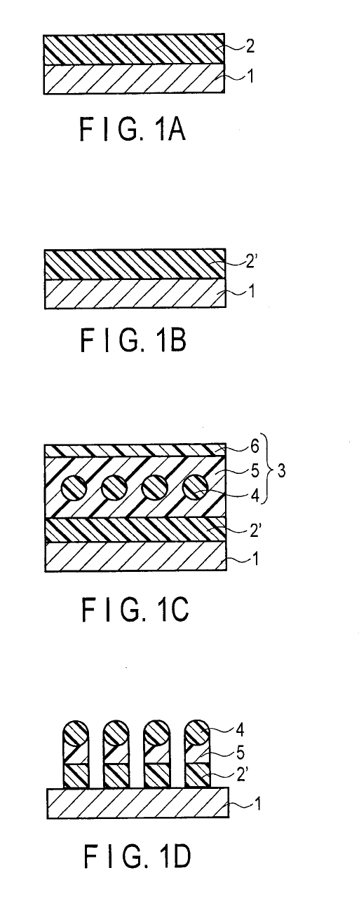

FIGS. 1A to 1D schematically show the pattern formation method according to the embodiment.

The pattern formation method will be explained with reference to schematic drawings. As the material of a mask template, a PS-b-PDMS diblock copolymer in which a continuous phase to be brought into contact with a substrate was PS was used.

A Si substrate 1 was used as the substrate. First, organic contaminations adhered on the Si substrate were removed by cleaning it for 5 minutes by using a UV cleaning apparatus, and the substrate surface was hydrophilized.

After that, as shown in FIG. 1A, a toluene solution prepared by dissolving polystyrene (PS) having a hydroxyl group at the terminal end as a medium was dropped on the hydrophilized substrate 1, and the solvent was volatilized after spin coating was performed, thereby forming a PS coating film as a surface treatment polymer film 2 on the Si substrate surface.

The molecular weight of PS used was set at 3,000, and the concentration of the solution was set at 0.8 wt %. After that, as shown in FIG. 1B, the Si substrate having the PS coating film was heated in a vacuum ambient at 170° C. for 20 hours, thereby causing a hydrolysis reaction between a hydroxyl group on the substrate surface and a hydroxyl group at the PS terminal end, and forming a PS brush layer 2′. Subsequently, extra PS not used in the hydrolysis reaction but remaining on the substrate 1 was removed by applying a styrene monomer to the surface of the brush layer 2′. After extra PS was removed, the thickness of the PS brush layer 2′ formed on the substrate was about 3 nm.

A block copolymer film 3 was formed on the obtained substrate 1. The block copolymer used was a diblock copolymer (PS-b-PDMS) containing PS and PDMS as monomers. Number average molecular weights Mn of a PS block chain and PDMS block chain forming PS-b-PDMS were respectively 11,800 and 2,700, and a molecular weight distribution Mw/Mn was 1.09. In PS-b-PDMS used, the volume fraction of PDMS is about 19%. When thermal annealing is performed, PDMS forms a spherical phase, and PS forms a continuous phase, thereby forming 20-nm-pitch spherical patterns.

A polymer solution having a concentration of 1.5 wt % was prepared by dissolving PS-b-PDMS in propyleneglycol-1-monomethylether-2-acetate (PGMEA) as a solvent. This polymer solution mixture was dropped on the substrate surface, and the solvent was volatilized after spin coating was performed, thereby forming a diblock copolymer coating film on the substrate surface. The thickness of the coating film was adjusted to 20 nm by adjusting the solution concentration and the rotational speed of a spin coater.

Then, the substrate on which the coating film was formed was heated in a vacuum ambient at 170° C. for 20 hours, thereby forming a self-assembled layer 3 having a microphase-separated structure in which PDMS formed a spherical phase 4 and PS formed a continuous phase 5 as shown in FIG. 1C. Note that PS of the continuous phase 5 mixed with PS in the grafted layer 2′, so the grafted layer 2′ can be regarded as a part of the continuous phase 5.

In the step of forming the microphase-separated structure, it is also possible to perform solvent annealing in which the diblock copolymer was kept in a solvent ambient having solubility, instead of above-mentioned thermal annealing.

Then, the patterns formed by microphase-separation were etched by using an inductively coupled plasma (ICP) RIE. First, a PDMS layer 6 formed on the polymer film surface was etched by using CF₄ as a process gas. In this etching, the chamber pressure was set at 0.1 Pa, the coil RF power and platen RF power were respectively set at 100 and 2 W, and the etching time was set at 10 seconds.

Subsequently, as shown in FIG. 1D, the PS continuous phase and grafted layer 2′ were etched by using oxygen as a process gas and using the PDMS spherical phase 4 as a mask. In this etching, the chamber pressure was set at 0.1 Pa, the coil RF power and platen RF power were respectively set at 50 and 15 W, and the etching time was set at 100 seconds.

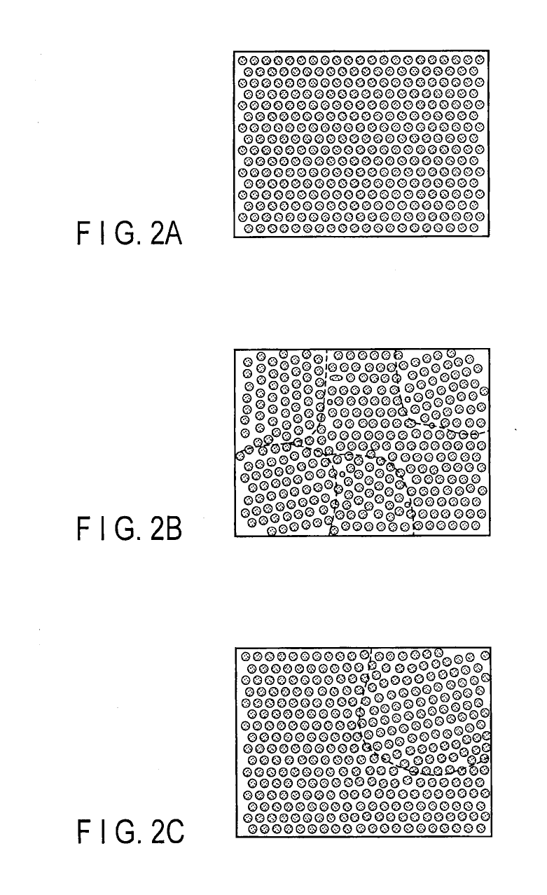

FIG. 2A is a view schematically showing an upper-surface SEM image of the etching patterns according to Example 1.

As shown in FIG. 2A, etching patterns made of the PDMS spherical phase were confirmed, and six etching patterns were coordinated around each etching pattern, thereby forming a regular array. It was also confirmed that this hexacoordinate regular array was formed over a broad range of about 10 μm.

### Comparative Example 1

In Comparative Example 1, organic solvents other than a monomer of a polymer were applied to the surface of a grafted layer 2′, thereby removing an extra polymer not used in a hydrolysis reaction but remaining on a substrate 1. Comparative Example 1 is the same as Example 1 except for the types of organic solvents used in cleaning.

The organic solvents used were seven solvents, i.e., PGMEA, toluene, tetrahydrofuran (THF), anisole, cyclopentanone, N-methylpyrrolidone (NMP), and benzyl alcohol. Each organic solvent can dissolve PS.

As in Example 1, a polymer film made of PS was formed on a Si substrate, and an extra PS film on the substrate was removed by using each of the aforementioned seven types of organic solvents. After that, a PS-b-PDMS diblock copolymer film was formed on the substrate, and a microphase-separated structure was formed by thermal annealing.

FIGS. 2B and 2C are schematic views showing upper-surface SEM images of etching patterns of the diblock copolymer formed on substrates cleaned by using benzyl alcohol and toluene as organic solvents. Referring to FIGS. 2B and 2C, each dotted line indicates the boundary between domains, i.e., the domain boundary indicating hexacoordination. The domain size was measured with an SEM at a magnification of ×50,000 to ×100,000, and the average value of domain sizes observed when measurement was performed about 10 times was used.

On the substrate formed in Example 1, as shown in FIG. 2A, no domain boundary was found in a visual field observed by an SEM of ×300,000. A domain boundary was found on the substrate formed in Comparative Example 1 and cleaned with toluene, and the size of domains confirmed in a wide-range SEM image was about 2 μm. In addition, as shown in FIG. 2B, many domain boundaries were found on the substrate cleaned with benzyl alcohol, and the size of domains was about 200 nm.

To check the wettability of PS forming the PS-b-PDMS continuous phase to the substrate, the contact angle of PS of the substrate was measured. Since PS has a melting point of about 110° C. and hence is a solid at room temperature, the contact angle was measured using styrene as a monomer of PS. Table 2 below shows the contact angle of styrene of each substrate, and domain sizes observed by an SEM.

TABLE 2

| | Styrene contact | Domain size |
|---|---|---|
| Cleaning solvent | angle (°) | (diameter, μm) |
| Styrene | 0 | 10 |
| PGMEA | 10 | 1 |
| Toluene | 6 | 2 |
| THF | 12 | 1 |
| Anisole | 15 | 0.7 |
| Cyclopentanone | 14 | 0.6 |
| NMP | 20 | 0.4 |
| Benzyl alcohol | 24 | 0.2 |

The results of the measurements reveal that the contact angle of styrene of only a substrate cleaned with styrene was zero, indicating a high wettability to the substrate. The measurement results also reveal that the formed domain size and the contact angle measured by using styrene were correlated: a domain size to be formed was small on a substrate having a large contact angle. This was so probably because PS-PDMS as the diblock copolymer had a low wettability to the substrate, so a stress occurred in the diblock copolymer film and disturbed the array patterns.

### Example 2

In this example, a method in which Au fine particles each coated with a polystyrene protective group were used as a mask template will be explained.

The diameter of the Au fine particles used was about 10 nm, and polystyrene containing a sulfur element at the terminal end and having an average molecular weight of 3,000 was used as the protective group. The surface of the Au fine particle was coated via an Au—S bond. Also, to widen the spacing between the fine particles, polystyrene having an average molecular weight of 1,500 was added at a mass percent concentration of 15% to the Au fine particles. This polystyrene functioned as a binder between the fine particles and between the substrate and fine particles when a substrate was coated with the fine particles.

Toluene was used as a solvent, and a total solute containing the Au fine particles and polystyrene was prepared to have a mass percent concentration of 3%.

Silicon was used as the substrate. After the substrate was cleaned by a UV cleaning apparatus for 10 minutes before being subjected to an experiment, a solution prepared by dissolving PS containing a hydroxyl group at the terminal end and having an average molecular weight of 5,000 in a toluene solvent was dropped on the substrate, and a coating film was formed by spin coating. Then, heating was performed in a vacuum ambient at 170° C. for 20 hours, thereby forming a brush layer of PS on the substrate. After that, styrene was dropped on the substrate to dissolve extra PS not reacted with substrate, and clean the substrate.

A prepared Au fine particles layer solution was dropped on the layer to be processed of the cleaned substrate by using an automatic syringe, and a monolayered Au fine particle layer was obtained by performing spin coating at a rotational speed of 5,000 rpm.

The substrate coated with the fine particles was observed by using an SEM. Consequently, the Au fine particles kept dispersing from each other, and no aggregation was found on the substrate. Also, when the thickness of the metal fine particle layer was measured using an atomic force microscope (AFM), a step of 14 nm was found, i.e., the fine particles formed a monolayer.

### Comparative Example 2

In this example, a method in which the same mask template material as that of Example 2 was used and a solvent to be applied to a surface treatment polymer film was changed will be explained.

Comparative Example 2 is the same as Example 2 except that solvents other than styrene were used.

Substrates coated with fine particles and formed by using PGMEA, toluene, anisole, and benzyl alcohol as organic solvents were observed by using an SEM. Consequently, aggregation was found on the substrates, and a region where the substrate was not coated with the fine particles and the substrate surface was exposed was formed. When the area of each exposed region was evaluated, the area was 0.03 μm² for PGMEA, 0.016 μm² for toluene, 0.1 μm² for anisole, and 0.8 μm² for benzyl alcohol.

### Example 3

In this example, a method in which the thickness of a surface treatment polymer film was changed will be explained. Example 3 is the same as Example 1 except that the thickness of the surface treatment polymer film was changed.

PS materials having different molecular weights were used as surface treatment polymer materials, and formed on substrates in the same manner as in Example 1, and extra PS that was not chemically adsorbed was removed by using styrene as a monomer of PS. After that, the thicknesses of chemically adsorbed PS films were measured. The measured film thicknesses were 1.5, 2.3, 3.1, 5.0, 8.2, and 10.3 nm.

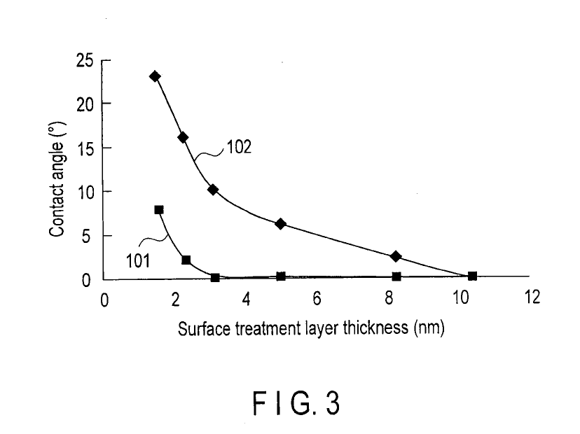

FIG. 3 shows a result obtained when the contact angle between the cleaned substrate and styrene was measured. The measurement result reveals that the angle of contact to styrene was zero when the thickness of the grafted layer was 3.1 nm or more.

After that, in the same manner as in Example 1, a diblock copolymer layer was formed on each substrate, and PS forming a continuous phase was removed by etching. When the domain size of a dot array on each substrate was measured, the domain size was about 10 μm in a medium having a thickness of 3.1 nm or more with which the contact angle was zero. On the other hand, the domain size was about 5 μm on a 2.3-nm-thick substrate, and about 2 μm on a 1.5-nm-thick substrate.

### Comparative Example 3

In this comparative example, a method in which the thickness of a surface treatment polymer film was changed in the same manner as in Example 3 and toluene was used as a cleaning solvent will be explained. This comparative example is the same as Example 3 except that toluene was used as the cleaning solvent.

When the thickness of the surface treatment polymer film was measured after extra PS not reacted with substrate was removed by using toluene, the thickness was the same as that when cleaning was performed by using styrene.

Referring to FIG. 3, a curve 102 indicates the relationship between the thickness of the surface treatment polymer film and the contact angle when toluene was used, and a curve 101 indicates the relationship between the thickness of the surface treatment polymer film and the contact angle when styrene was used in Example 3.

As shown in FIG. 3, the measurement result reveals that the contact angle was zero in a medium in which the thickness of the grafted layer was 10.3 nm. The measurement result also reveals that as the thickness of the surface treatment polymer film decreased, the contact angle increased due to the influence of the surface energy of the substrate.

After that, in the same manner as in Example 1, a diblock copolymer layer was formed on each substrate, and PS forming a continuous phase was removed by etched. When the domain size of the dot array of each substrate was measured, the domain size was about 10 μm on a substrate having a thickness of 10.3 nm with which the contact angle was zero. On substrates having a thickness of 10 nm or less, the domain size decreased in accordance with the thickness: the domain size was about 5 μm on an 8.2-nm-thick substrate, about 3 μm on a 5.0-nm-thick substrate, and about 1 μm on a 3.1-nm-thick substrate.

### Example 4

In this example, a method in which an alternative solvent was used when a monomer to be applied to a polymer film was a gas will be explained.

A Si substrate was used as a substrate, and the substrate was hydrophilized by UV cleaning beforehand. After polyethylene oxide (PEO) containing a silanol group at the terminal end and having a molecular weight of 4,000 was diluted to about 10 times the volume with methanol, the substrate was coated with the solution to adsorb the silanol group to the substrate, thereby obtaining a polymer film. A silanol group is unstable and hence sufficiently reacts with a substrate even at room temperature. However, the substrate can also be heated in order to increase the adsorption density to the substrate.

The formed substrate is cleaned with ethylene oxide as a monomer of polyethylene oxide, but it is difficult to use ethylene oxide as a cleaning solvent because ethylene oxide is a gas at room temperature. Therefore, ethylene glycol obtained by hydrolyzing ethylene oxide can be used as the cleaning solvent. Since the viscosity of ethylene glycol is as very high as 16 mPa·s, ethylene glycol can be used as the cleaning solvent by decreasing the viscosity to about 1 mPa·s by diluting ethylene glycol with pure water. Note that when ethylene glycol is diluted with a solvent having a boiling point lower than that of a main solvent, a solvent to be entrapped in the surface treatment polymer film is the main solvent having a high boiling point, so the dilution has no influence on the wettability of the medium.

After the substrate on which the polymer film was formed was cleaned by using ethylene glycol diluted to 10% with pure water, the contact angle between the polymer film and ethylene glycol was measured. Consequently, the contact angle was zero, indicating that it was possible to improve the surface energy. Note that when the thickness of the cleaned surface treatment polymer film was measured, the thickness was about 4 nm.

After that, a PS-PEO layer as a mask template layer was formed on the polymer film cleaned with ethylene glycol. That is, a solute obtained by adding 20% of SOG having a molecular weight of 1,600 to PS and PEO each having a molecular weight of 3,000 was dissolved in diethylene glycol dimethyl ether, the mass percent concentration was adjusted to 1.0%, and the PS-b-PEO layer as a mask template layer was formed by spin coating.

When the substrate on which the mask template layer was formed was sintered at 400° C. for about 2 hours, PS and PEO entirely sublimated, and it was possible to form patterns made of a silicon product on the entire substrate. Pattern observation was performed using an SEM.

### Comparative Example 4

In this comparative example, a method in which a solvent totally different from a skeleton forming a surface treatment polymer film was used as a solution will be explained. This comparative example is the same as Example 3 except that the solution was changed.

After unreacted extra PEO was removed by using pure water as a solution to be applied to the surface treatment polymer film, the angle of contact to the surface treatment polymer film was measured using ethylene glycol. Consequently, the contact angle was about 6°. Also, when the contact angle was measured using pure water used in cleaning, the contact angle was 8°.

Following the same procedures as in Example 3, a mask template layer was formed on the substrate cleaned with pure water, and patterns made of a silicon product were formed by sintering. Consequently, defects of about 5 μm occurred everywhere on the substrate. Pattern observation was performed using an SEM.

### Example 5

In this embodiment, a step of transferring patterns to a hard mask formed by a carbon-silicon multilayered structure by using PS-b-PDMS for forming a 13-nm-pitch phase-separated shape as a diblock copolymer will be explained.

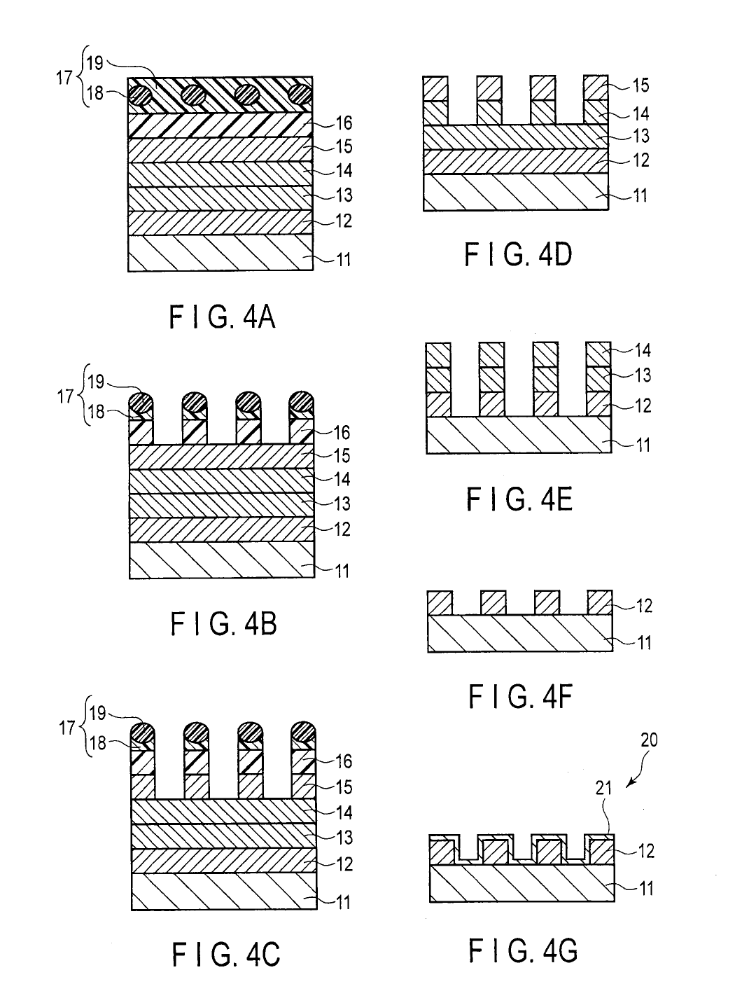

FIGS. 4A to 4G show the manufacturing method of the magnetic recording medium according to the embodiment.

A multilayered mask substrate formed by the following method was used as a substrate.

A glass substrate 11 (amorphous substrate MEL6 manufactured by Konica Minolta, diameter=2.5 in) was placed in a deposition chamber of a DC magnetron sputtering apparatus (C-3010 manufactured by Canon Anelva), and the deposition chamber was evacuated to an ultimate vacuum degree of 1×10⁻⁵ Pa.

10-nm-thick CrTi was formed as an adhesion layer (not shown) on the substrate 11. Then, a soft magnetic layer (not shown) was formed by deposing 40-nm-thick CoFeTaZr. 10-nm-thick Ru was formed as a nonmagnetic underlayer (not shown) on the soft magnetic layer. After that, as shown in FIG. 4A, 10-nm-thick Co-20 at % Pt-10 at % Ti was formed as a perpendicular magnetic recording layer 12. Subsequently, a 5-nm-thick Mo film was formed as a release layer 13, a 30-nm-thick C film was formed as a mask layer 14, and 5-nm-thick Si as a sub mask 15 for transferring patterns to the C mask was deposited on the C mask layer 14.

Following the same procedures as in Example 1, a PS coating film 16 was formed on the obtained substrate and cleaned with styrene, and a diblock copolymer film 17 was formed after that. As the diblock copolymer used in this example, a diblock copolymer (PS-b-PDMS) containing PS and PDMS as monomers was used. The number average molecular weights Mn of PS and PDMS block chains forming PS-b-PDMS were respectively 7,000 and 1,500, and the molecular weight distribution Mw/Mn was 1.06. In PS-b-PDMS used, the volume fraction of PDMS is about 19%. When thermal annealing is performed, PDMS forms a spherical phase 18, and PS forms a continuous phase 19, thereby forming 13-nm-pitch spherical patterns.

A polymer solution having a concentration of 1.0 wt % was prepared by dissolving PS-b-PDMS in propyleneglycol-1-monomethylether-2-acetate (PGMEA) as a solvent. This polymer solution mixture was dropped on the substrate surface, and the solvent was volatilized after spin coating was performed, thereby forming a diblock copolymer coating film on the substrate surface. The thickness of the coating film was adjusted to 14 nm by adjusting the solution concentration and the rotational speed of a spin coater.

Then, the substrate on which the coating film was formed was kept for 20 hours in an NMP solvent ambient that dissolved PS, thereby forming a microphase-separated structure in which PDMS formed a spherical phase 18 and PS formed a continuous phase 19.

Based on the phase-separated patterns, three-dimensional patterns were formed by using ICP-RIE.

First, to remove PDMS in the surface layer of a self-assembled film (not shown), etching was performed for 10 seconds by using CF₄ as a process gas at a coil RF power of 50 W and a platen RF power of 2 W. Then, to remove the PS phase 19 of the continuous film and the PS coating film 16, etching was performed for 90 seconds by using O₂ as a process gas at a coil RF power of 50 W and a platen RF power of 10 W. Consequently, three-dimensional patterns made of the diblock copolymer were formed as shown in FIG. 4B. Since this etching was performed using oxygen, Si stopped etching as a stopper.

Furthermore, as shown in FIG. 4C, the three-dimensional patterns were transferred to the PS coating film 16 and mask layer 15 as underlayers. The mask layer 15 was processed by ICP-RIE in the same manner as that for three-dimensional pattern formation in the self-assembled film. The Si layer was removed by performing etching for 40 seconds by using CF₄ as a process gas at a coil RF power of 50 W and a platen RF power of 5 W.

After that, as shown in FIG. 4D, pattern transfer to the C mask 14 was performed using the formed Si patterns 15 as masks. In this pattern transfer, etching was performed for 80 seconds by using O₂ as a process gas at a coil RF power of 100 W and a platen RF power of 10 W.

Then, as shown in FIG. 4E, Mo as the release layer 13 and the magnetic recording layer 12 were milled by Ar milling, thereby transferring the phase-separated patterns formed by PS-b-PDMS to the magnetic recording layer 12. Subsequently, as shown in FIG. 4F, Mo as the release layer 13 was removed by dipping the layer in H₂O₂. After H₂O₂ was adjusted to 1% as a percent by weight, a release solution was prepared by adding a nonion-based, fluorine-containing surfactant to H₂O₂, and the layer was removed by dipping the sample in the solution. After that, as shown in FIG. 4G, a magnetic recording medium 20 was obtained by forming a protective film 18 and a lubricating film (not shown).

When the pattern defect ratio of the medium obtained by the above-mentioned processing was evaluated, the pattern defect ratio was 0.8%. In addition, the head floating characteristic of the manufactured medium was evaluated. Consequently, no error occurred when the head floating amount was 5 nm, i.e., it was possible to obtain a good head floating characteristic.

### Comparative Example 5

To improve the wettability of a diblock copolymer to a substrate, the thickness of a polymer film formed on the substrate surface was changed.

A substrate identical to that used in Example 4 was used as the substrate. A toluene solution prepared by dissolving polystyrene (PS) having a hydroxyl group at the terminal end was dropped on a hydrophilized substrate 1, and the solvent was volatilized after spin coating was performed, thereby forming a polymer film of PS. After an extra polymer was removed by toluene, the contact angle of PS was measured. Consequently, the contact angle of PS was zero in a 12.2-nm-thick polymer film in which the molecular weight of PS was 15,000.

PS having a molecular weight of 15,000 described above was used as a polymer material, mask patterns were formed following the same procedures as in Example 4.

When three-dimensional patterns were formed based on a phase-separated shape of PS-b-PDMS by using ICP-RIE, each pattern had a hexacoordinate regular array, and the domain size was about 7 μm.

After that, pattern formation to a magnetic recording layer and mask removal were performed following the same procedures as in Example 4. When the pattern defect ratio of the obtained medium was evaluated, the defect ratio increased to 5%. In addition, when the head floating characteristic of the manufactured medium was evaluated, an error occurred when the head floating amount was 5 nm.

This is perhaps because the thickness of the polymer layer formed on the substrate surface was four times or more the thickness in Example 2, so a pattern defect occurred when transferring the patterns to the hard mask.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern formation method comprising:
forming a surface treatment polymer film on a substrate by using a surface treatment polymer material;
applying a solution containing a monomer or oligomer of the surface treatment polymer material to a surface of the surface treatment polymer film;
coating the surface treatment polymer film, to which the solution containing the monomer or oligomer of the surface treatment polymer material is applied, with a block copolymer coating solution containing a block copolymer having at least two types of polymer chains and a first solvent, thereby forming a self-assembled layer made of the block copolymer;
forming a microphase-separated structure in the self-assembled layer by annealing the substrate; and
optionally removing one type of a polymer layer from the microphase-separated structure to form convex patterns by a remaining polymer layer.

2. The method according to claim 1, wherein the surface treatment polymer film is polystyrene, and the monomer is styrene.

3. The method according to claim 1, wherein the surface treatment polymer film has a thickness of 3 to 10 nm.

4. A pattern formation method comprising:
forming a surface treatment polymer film on a substrate by using a surface treatment polymer material;
applying a solution containing a monomer or oligomer of the surface treatment polymer material to a surface of the surface treatment polymer film; and
coating the surface treatment polymer film, to which the solution containing the monomer or oligomer of the surface treatment polymer material is applied, with a metal fine particle coating solution containing metal fine particles and a second solvent, thereby forming a metal fine particle layer.

5. The method according to claim 4, wherein the surface treatment polymer film is polystyrene, and the monomer is styrene.

6. The method according to claim 4, wherein the surface treatment polymer film has a thickness of 3 to 10 nm.

7. A magnetic recording medium manufacturing method comprising:
forming a surface treatment polymer film on a magnetic recording medium by using a surface treatment polymer material;
applying a solution containing a monomer or oligomer of the surface treatment polymer material to a surface of the surface treatment polymer film;
coating the surface treatment polymer film, to which the solution containing the monomer or oligomer of the surface treatment polymer material is applied, with a block copolymer coating solution containing a block copolymer having at least two types of polymer chains and a first solvent, thereby forming a self-assembled layer made of the block copolymer;
forming a microphase-separated structure in the self-assembled layer by annealing the magnetic recording medium;
optionally removing one type of a polymer layer from the microphase-separated structure to form convex patterns by a remaining polymer layer; and
transferring the convex patterns to a magnetic recording layer of the magnetic recording medium.

8. The method according to claim 7, wherein the surface treatment polymer film is polystyrene, and the monomer is styrene.

9. The method according to claim 7, wherein the surface treatment polymer film has a thickness of 3 to 10 nm.

10. A magnetic recording medium manufacturing method comprising:
forming a surface treatment polymer film on a magnetic recording medium by using a surface treatment polymer material;
applying a solution containing a monomer or oligomer of the surface treatment polymer material to a surface of the surface treatment polymer film;
coating the surface treatment polymer film, to which the solution containing the monomer or oligomer of the surface treatment polymer material is applied, with a metal fine particle coating solution containing metal fine particles and a second solvent, thereby forming a metal fine particle layer; and
transferring three-dimensional patterns based on the metal microparticles to a magnetic recording layer of the magnetic recording medium.

11. The method according to claim 10, wherein the surface treatment polymer film is polystyrene, and the monomer is styrene.

12. The method according to claim 10, wherein the surface treatment polymer film has a thickness of 3 to 10 nm.
